(19) United States
(12) Patent Application Publication
(10) Pub. No.: US 2008/0292512 A1
(43) Pub. Date: Nov. 27, 2008

(54) METHOD FOR PRODUCING AND USING A CARBONACEOUS SORBENT FOR MERCURY REMOVAL

(76) Inventor: Shin G. Kang, Simsbury, CT (US)

Correspondence Address: ALSTOM POWER INC.;INTELLECTUAL PROPERTY LAW DEPT., P.O. BOX 500, WINDSOR, CT, 06095, US

(21) Appl. No.: 12/185,478

(22) Filed: Aug. 4, 2008

Related U.S. Application Data
(63) Continuation-in-part of application No. 10/961,697, filed on Oct. 8, 2004.
Application No. 10/961,697 is a continuation-in-part of application No. 10/453,140, filed on Jun. 3, 2003, now Pat. No. 6,848,374.
(60) Provisional application No. 60/954,408, filed on Aug. 7, 2007.

(51) Int. Cl. B01D 53/64; B01D 53/14

(52) U.S. Cl. 422/172; 110/345; 95/134

(57) ABSTRACT

A method for removing mercury from flue gas comprises: applying a precursor of a sticky substance to surfaces of carbonaceous sorbent particles; injecting the carbonaceous sorbent particles into contact with flue gas, wherein the carbonaceous sorbent particles adsorb mercury from the flue gas and at least one of a temperature of the flue gas and a component of the flue gas changes the precursor into the sticky substance that increases the stickiness of the carbonaceous sorbent particles; and removing the carbonaceous sorbent particles having mercury adsorbed thereon from the flue gas. In one embodiment, the precursor is ammonia or an ammonia compound and the sticky substance is ammonium sulfate. The method may further comprise applying bromine or a bromine compound to the carbonaceous sorbent particles.

### CROSS-REFERENCE TO RELATED APPLICATIONS

This application claims the benefit of US Provisional Patent Application No. 60/654,408, filed Aug. 7, 2007, pending, and is a continuation-in-part of U.S. patent application Ser. No. 10/961,697, filed Oct. 8, 2004, which is a continuation-in-part of U.S. patent application Ser. No. 10/453,140, filed Jun. 3, 2003, each of which is incorporated by reference herein in its entirety.

### BACKGROUND

The present disclosure relates to a carbonaceous sorbent for removal of mercury from flue gas and a process for making the carbonaceous sorbent.

Various methods for mercury control in coal-fired power plants are being developed and demonstrated to meet current and impending mercury emission regulations. These technologies include activated carbon (AC) injection, coal and flue gas additives, catalytic and electro-catalytic mercury oxidation with subsequent capture in scrubbers, and in-situ mercury sorbent generation from coal. Among these, injection of powdered AC is one of the more mature technologies for mercury control.

Carbonaceous sorbents such as AC have been proposed for controlling vapor phase mercury emissions in power plant flue gases. In a conventional method, carbonaceous sorbents are injected in the flue gas duct upstream of particulate removal device such as baghouses and electrostatic precipitators and downstream of air heaters.

One example of a method for controlling mercury emissions in power plant flue gases is provided in co-pending U.S. patent application Ser. No. 10/961,697, filed Oct. 8, 2004 and entitled “Control of Mercury Emissions From Solid Fuel Combustion”, which is incorporated by reference herein in its entirety.

In demonstration projects, it has been observed that high injection rates of plain (untreated) AC were needed to achieve reasonable levels of mercury removal, particularly for low-chlorine containing sub-bituminous (Powder River Basin-PRB) and lignite coals. The low removal levels could be ascribed to a high proportion of elemental mercury in the flue gas when firing these coals. Researchers and technology developers have since determined that the use of halogenated carbon sorbents significantly improves the mercury collection efficiency as compared to plain AC.

U.S. Pat. No. 6,953,494 to Nelson, Jr., which is incorporated by reference herein in its entirety, describes a process that impregnates gas phase bromine (Br2) or hydrogen bromide (HBr) onto the AC particle. Data that has been presented to date indicates that the sorbent prepared in this manner resulted in improved mercury capture performance as compared to plain AC. U.S. Pat. No. 4,500,327 to Nishino et al., which is incorporated by reference herein in its entirety, describes a sorbent comprising an activated carbon having supported thereon a two or more component compound, where one components is selected from sulfur and various sulfates and nitrates of Al, V, Fe, Co, Ni. Cu, Zn or NH₄, and another component is selected from: oxide of iodine, oxyacid corresponding to the oxide of iodine, salt of said oxyacid, and bromide and iodide of K, Na or NH₄.

While use of halogenated carbon sorbents has resulted in improved mercury capture, there remains a need for further improvement.

### SUMMARY

A method for removing mercury from flue gas comprises: applying a precursor of a sticky substance to surfaces of carbonaceous sorbent particles; injecting the carbonaceous sorbent particles into contact with flue gas, wherein the carbonaceous sorbent particles adsorb mercury from the flue gas and at least one of a temperature of the flue gas and a component of the flue gas changes the precursor into the sticky substance that increases the stickiness of the carbonaceous sorbent particles; and removing the carbonaceous sorbent particles having mercury adsorbed thereon from the flue gas. In one embodiment, the precursor is ammonia or an ammonia compound and the sticky substance is ammonium sulfate.

The method may further comprise applying bromine or a bromine compound to the carbonaceous sorbent particles. In one embodiment, the precursor of the sticky substance is NH4Br, and the injecting step includes injecting the carbonaceous particles into contact with flue gas having a temperature at an initial point of contact with the carbonaceous sorbent of at least 400 degrees F. to decompose ammonia and bromine from the NH4Br. The precursor may be applied on-site at the plant where the carbonaceous sorbent particles are to be used for mercury removal

The above described and other features are exemplified by the following figures and detailed description.

### BRIEF DESCRIPTION OF THE DRAWINGS

Referring now to the figures, which are exemplary embodiments, and wherein the like elements are numbered alike:

FIG. 1 is a flow chart depicting a method for producing a carbonaceous sorbent for mercury capture in accordance with a first embodiment of the present invention;

FIG. 2 is a schematic diagram depicting an example of a solid fuel combustion plant using the carbonaceous sorbent produced using the method of FIG. 1;

FIG. 3 is a flow chart depicting a method for producing a carbonaceous sorbent for mercury capture in accordance with a second embodiment of the present invention;

FIG. 4 is a flow chart depicting a method for producing carbonaceous sorbent for mercury capture in accordance with a third embodiment of the present invention;

FIG. 5 is a schematic diagram depicting an example of a solid fuel combustion plant using the carbonaceous sorbent produced using the method of FIG. 4;

FIG. 6 is a flow chart depicting a method for producing a carbonaceous sorbent for mercury capture in accordance with a fourth embodiment of the present invention; and

FIG. 7 is a schematic diagram depicting an example of a solid fuel combustion plant using the carbonaceous sorbent produced using the method of FIG. 6.

### DETAILED DESCRIPTION OF THE PREFERRED EMBODIMENT

A unique sorbent formulation, as described herein, is believed to show significant improvement with respect to mercury capture from flue gas as compared to plain activated carbon (AC) as well as other halogenated sorbents. In accordance with the invention, a precursor of a sticky substance is applied to surfaces of carbonaceous sorbent particles before injecting the carbonaceous sorbent particles into contact with the flue gas. The carbonaceous sorbent particles adsorb mercury from the flue gas and at least one of a temperature of the flue gas and a component of the flue gas changes the precursor into the sticky substance that increases the stickiness of the carbonaceous sorbent particles. In one embodiment, the precursor is ammonia or an ammonia compound and the sticky substance is ammonium sulfate. Preferably, a bromine or bromine compound is also applied to the carbonaceous sorbent. For example, ammonium bromide (NH₄Br) may be applied to the carbonaceous sorbent substrate. As used herein, the term “sticky” means having the ability to adhere to surfaces in the flue gas path or to other sorbent particles. The stickiness of the sorbent is believed to increase residence time of the sorbent in the flue gas stream (e.g., by adhering to surfaces encountered by the flue gas stream), which results in increased mercury removal capability.

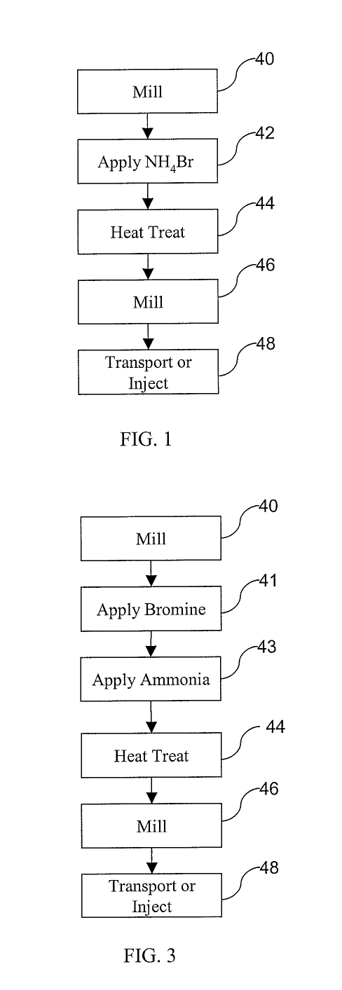

Referring to the flow chart of FIG. 1, an example of a process employing an aspect of the present invention is described as follows for the case of using granular activated carbon (GAC) as the carbonaceous substrate:
1) Virgin or re-activated AC is ground (milled) (block 40) to produce a GAC (e.g., approximately 8×30 mesh size). The activated carbon feedstock can be either lignite or bituminous coal.
2) The GAC is fed into a heat treating device (e.g., a rotary kiln). An aqueous solution of NH₄Br is applied onto the granular AC as it is being fed into the heat treating device (block 42). The amount of NH₄Br is preferably about 1 to about 25 weight percent of the granular AC.
3) The heat treating device is operated to heat the AC to temperatures between about 400 and about 1,100 degrees Fahrenheit (F) (block 44). For example, the heat treating device may be operated to heat the AC to temperatures between about 550 and about 1000 degrees F. The temperature at which the carbonaceous sorbent is heat treated may be approximately equal to the temperature of the flue gas into which the sorbent is to be injected to prevent any decomposition or release of bromine into the flue gas.
4) Residence time in the heat treating device may be up to about 3 hours, depending upon the amount of NH₄Br that was applied and the size of the heat treating device. For a rotary kiln, for example, residence time is between about 30 minutes and about 3 hours depending upon the amount of NH₄Br that was applied, the heat treating temperature, and the size of the rotary kiln. The minimum residence time is generally that which is necessary to dry the NH₄Br solution on the carbonaceous substrate.
5) As the GAC exits the heat treating device, it is slowly cooled to ambient temperature.
6) Once cooled, the GAC is ground via a milling apparatus (block 46) to produce a powdered activated carbon (PAC), preferably to a size distribution of about 90-95% less than 325 mesh.
7) The NH₄Br laden PAC may then be loaded into either a bulk handling truck or bulk bags for delivery to the end user (block 48). It is also contemplated that the sorbent preparation process may be performed on-site at the plant where the carbonaceous sorbent is to be used for mercury removal, in which case, the NH₄Br laden PAC may be injected into contact with the flue gas to remove mercury therefrom or stored on-site for later use.

While the above example describes the use of GAC as the carbonaceous sorbent substrate, it is contemplated that different materials can be used. By way of example, but not intending to be limiting, possible carbonaceous sorbent substrate materials comprise: activated carbon in powdered or raw form, activated charcoal, activated coke, char, and unburned or partially-burned carbon from a combustion process. The important features of the sorbent substrate material are that it is significantly composed of carbon and that it has an adequate degree of porosity or surface area to enable it to provide mercury removal in the process. In the method of FIG. 1, the aqueous solution of NH₄Br may be applied to the carbonaceous substrate by spraying or immersion (e.g., a slurry).

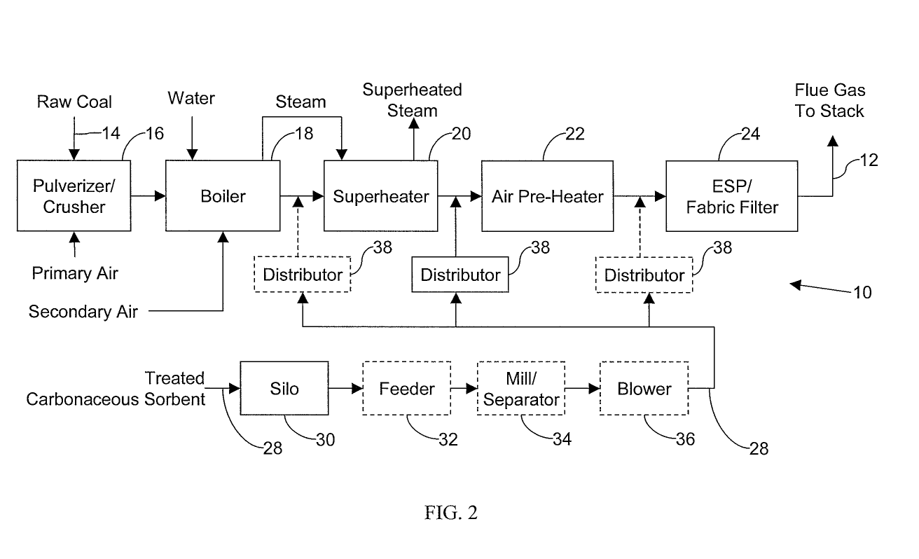

FIG. 2 is a schematic diagram depicting various injection points for a carbonaceous sorbent 28 produced using the method described above in a plant 10 in which solid fuel (e.g., coal) combustion creates a flue gas. The system of FIG. 1 is shown for example only, and it will be appreciated that carbonaceous sorbent produced using the method described above may be used in conjunction with any system in which carbonaceous sorbent is used for mercury capture from flue gas.

In the plant 10, solid fuel 14 is fed to a pulverizer/crusher 16 where the solid fuel 14 is reduced to particulate size. Primary air carries the solid fuel 14 particulates from the pulverizer/crusher 16 to a boiler 18, where the solid fuel 14 is burned to convert water into steam. The temperature of the flue gases leaving the boiler 18 may range from about 1400 to about 2200° F. The flue gases are cooled in a superheater and convective pass 20 (economizer/re-heater) to a temperature of about 600 to about 800° F. before entering an air preheater 22. Flue gas temperatures exiting the air preheater 22 and entering a particle separator (e.g., electrostatic precipitator (ESP), fabric filter, cyclone, or the like) 24 may range from about 220 to about 370° F.

Sorbent 28 treated using the process described above may be stored in a silo 30. The sorbent 28 may be fed by a feeder 32 to an optional separation device 34, which comminutes (if necessary) and de-agglomerates the sorbent particles 28 into a contact batch of carbonaceous sorbent and a retained batch of carbonaceous sorbent. This device 34 may be a particle-particle separator or a jet mill, where compressed air or high-pressure steam is the energy source. In addition to handling thereof by the separation device 34, it is contemplated that the sorbent particles 28 may be subjected to one or more optional processes (not shown) before they are injected into the stream of flue gas. The sorbent 28 may then be introduced into the flue gas stream by one or more distributors 38 (e.g. nozzles, lances, or other mechanical devices) under the force of a blower 36. Preferably, there is no storage of the carbonaceous sorbent particles 28 between the time the particles are de-agglomerated by separation device 34 and the time they are injected into the flue gas stream by the distributors 38, thereby preventing re-agglomeration of the particles and a resulting reduction in their mercury removal ability.

The sorbent 28 may be injected into the flue gas stream 12 at any one or more points between the boiler 18 and the convective pass/superheater 20, between the convective pass/superheater 20 and the air preheater 22, or between the air preheater 22 and the ESP/fabric filter 24.

Preferably, the sorbent is injected at a location where interaction between injected sorbent and mercury in flue gas is maximized both for (1) oxidation of mercury on sorbent surface and for (2) its subsequent capture by sorbent. The following three types of temperatures may be taken into account in determining the sorbent injection location: injection temperature, collection temperature and exposure temperature range. In this regard, the injection temperature is deemed to be the temperature of the location at which the sorbent and the flue gas are first in contact with one another. Also, the collection temperature is deemed to be the temperature of a given collection location at which carbonaceous sorbent having mercury absorbed thereon is separated from the flue gas either with or without other solids, gases, or liquids entrained with the flue gas. Accordingly, a given collection location may be a respective known particulate removal device such as a cyclone, an electrostatic precipitator (ESP), a baghouse, or a particulate scrubber.

In one embodiment, the injection temperature may be from about 400 to about 1100° F., and the sorbent collection temperature from about 100 to about 800° F. The exposure temperature range is bound by the injection temperature—namely, the flue gas temperature at which sorbent is injected—and the collection temperature—namely, the flue gas temperature at which the majority of the sorbent is removed from the flue gas. In this embodiment, the exposure temperature range (injection temperature minus collection temperature) is preferably greater than about 50° F., preferably greater than about 100° F., and more preferably greater than about 200° F. (temperature drop due to spray dryer excluded).

It is believed that with the injection of activated carbon at temperatures higher than about 400° F. into a flue gas obtained from the combustion of coal, mercury oxidation and removal were higher than if injected at lower temperatures. However, there is an upper limit in temperature to be taken into account in selecting the injection point. The selection of this limit, which is believed to be about 1100° F., takes into account the reaction of activated carbon with oxygen in the flue gas at high temperatures, which results in the consumption of the activated carbon.

These temperature limits identify the preferred temperature range for carbon injection for mercury capture and oxidation. However, it is to be understood that the above-identified temperature limits will differ for different types of carbonaceous material, for the gas compositions they are subjected, and the residence time the carbon is exposed at the high temperature. Hence, efficacious capture of mercury in flue gas via injection of a carbonaceous sorbent at relatively higher temperatures should be expected to be constrained only by the process limits such as noted above and not by the absolute specific temperature targets.

Furthermore, testing has shown that a PAC sorbent produced using the method described with reference to FIG. 1 provides for greater removal of mercury from flue gas as compared to the same amounts of plain (untreated) AC and AC treated with bromine alone when injected in the manner described in FIG. 2 at higher flue gas temperatures (400 to 1,100 degrees F.). While not wanting to be bound by theory, it is believed that when PAC treated with NH₄Br is heated to temperatures of at least 400 degrees F., the NH₄Br decomposes into ammonia (NH₃) and bromine (Br₂) or hydrogen bromide (HBr), after which the ammonia reacts with sulfur dioxide in the flue gas stream to form ammonium sulfate, which is a sticky substance. The stickiness of the sorbent is believed to increase residence time of the sorbent in the flue gas stream (e.g., by adhering to surfaces encountered by the flue gas stream), which results in increased mercury removal capability.

FIG. 3 is a flow chart depicting an alternative method for producing carbonaceous sorbent 28 that may be used in the solid fuel combustion plant 10 of FIG. 2. The method of FIG. 3 is substantially similar to the method of FIG. 1, except rather than treating the carbonaceous sorbent with NH₄Br as in the method of FIG. 1, the carbonaceous sorbent of FIG. 3 is subjected to separate treatments of bromine or a bromine-containing compound (hereafter “bromine”) and ammonia (NH₃) or an ammonia compound. For example, Br₂ or HBr may be applied to the carbonaceous sorbent in liquid or gaseous form (block 41), and thereafter NH₃ is applied to the carbonaceous sorbent in liquid or gaseous form (block 43). It will also be appreciated that the ammonia may be applied before the bromine.

It is believed that a sorbent created using the method of FIG. 3 may be suitable for flue gas injection temperatures less than 400 degrees F. because, unlike sorbent treated with NH₄Br, high temperatures are not needed to ensure that ammonia (NH₃) is separated from bromine (Br₂) to react with sulfur dioxide in the flue gas stream and thereby form a sticky ammonium sulfate substance on the surface of the sorbent particles.

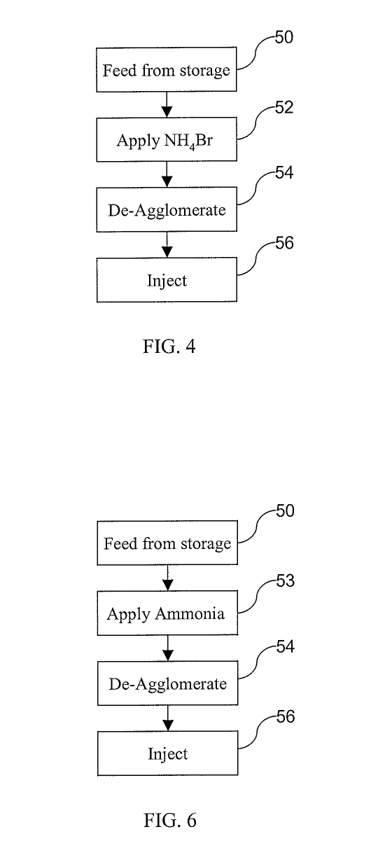

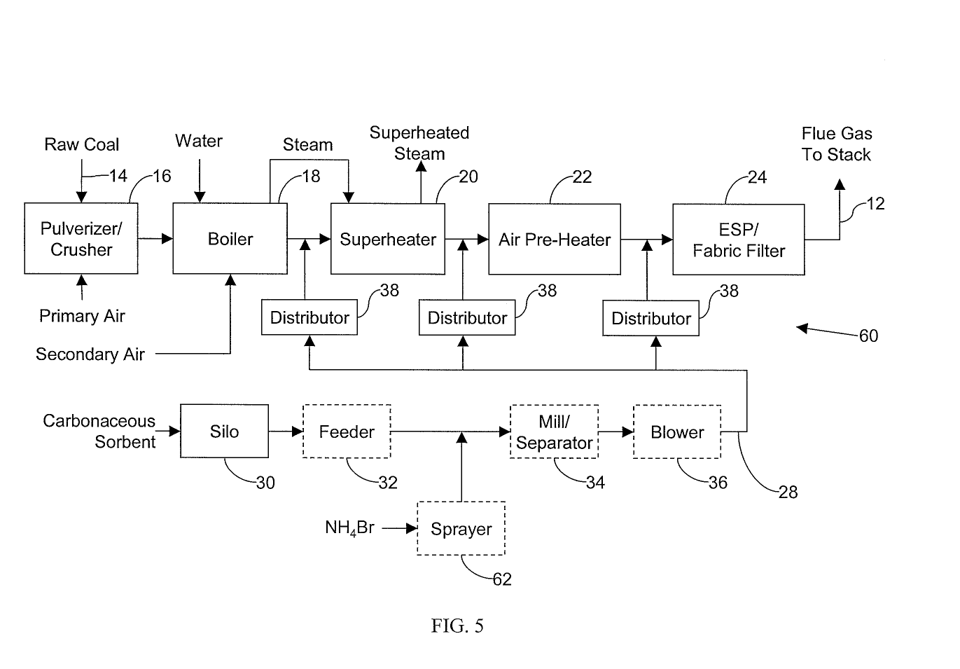

FIG. 4 is a flow chart depicting another alternative embodiment of the present invention, as may be employed in the plant 60 of FIG. 5. The plant 60 of FIG. 5 is substantially similar to plant 10 of FIG. 2, with like items numbered alike. Unlike plant 10 of FIG. 2, where carbonaceous sorbent treated with NH₄Br is stored prior to injection into the flue gas 12, in plant 60 of FIG. 5 the carbonaceous sorbent substrate is treated with NH₄Br as it travels to mill/separator 34 for de-agglomeration.

Referring to FIG. 4 and 5, carbonaceous sorbent 64 in granular or powdered form is fed from storage silo 30 (block 50) by feeder 32 to separation device 34. As the sorbent particles 64 are fed to the separation device 34, a sprayer 62 applies NH₄Br to the sorbent particles 64 to improve the mercury removal ability of the sorbent particles 64 (block 52). The mill/separator 34 comminutes (if necessary) and de-agglomerates the sorbent particles 64 (block 54), and the sorbent particles 64 are then introduced into the flue gas stream by one or more distributors 38 (e.g. nozzles, lances, or other mechanical devices) under the force of a blower 36 (block 56). The sorbent 64 may be injected into the flue gas stream 12 at any one or more points between the boiler 18 and the convective pass/superheater 20, between the convective pass/superheater 20 and the air preheater 22, or between the air preheater 22 and the ESP/fabric filter 24, as previously described with reference to FIG. 2. In the embodiment of FIG. 4 and FIG. 5, the injection temperature is preferably between about 400 to about 1,100 degrees F. to allow the hot flue gas to dry any aqueous NH₄Br remaining on the sorbent particles after injection and to ensure that ammonia (NH₃) is separated from bromine (Br₂) or hydrogen bromide (HBr) to react with sulfur dioxide in the flue gas stream and form a sticky ammonium sulfate substance on the surface of the sorbent particles.

While plant 60 of FIG. 5 is shown to include a sprayer 62 for applying an aqueous solution of NH₄Br to the carbonaceous sorbent substrate, it will be appreciated that the aqueous solution of NH₄Br may instead be applied to the carbonaceous substrate by immersion (e.g., a slurry).

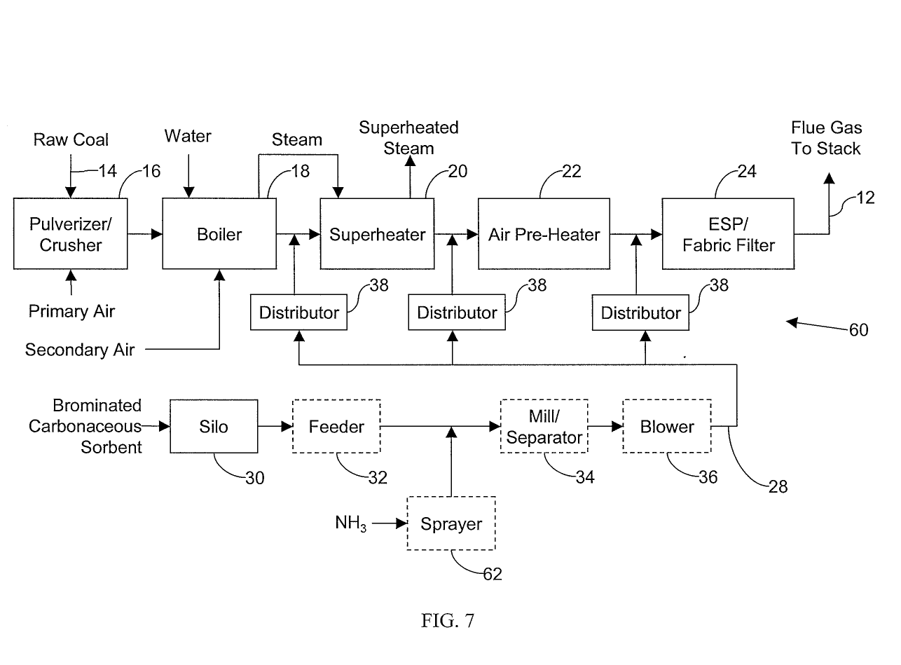

FIG. 6 is a flow chart depicting another alternative embodiment of the present invention, as may be employed in the plant 60 of FIG. 7. The plant 60 of FIG. 7 is substantially similar to plant 60 of FIG. 5, with like items numbered alike. Unlike plant 60 of FIG. 5, where carbonaceous sorbent is treated with NH₄Br prior to injection, in plant 60 of FIG. 7 brominated carbonaceous sorbent is stored in silo 30 and is treated with ammonia as it travels to mill/separator 34 for de-agglomeration. The carbonaceous sorbent stored in silo 30 may be treated with bromine, such as Br₂ or HBr. While plant 60 of FIG. 7 is shown to include a sprayer 62 for applying ammonia to the carbonaceous sorbent substrate , it will be appreciated that the ammonia may instead be applied to the carbonaceous substrate by immersion (e.g., a slurry). It is also contemplated that the ammonia may be applied in gaseous phase.

The embodiment of FIG. 6 and FIG. 7 may be suitable for flue gas injection temperatures less than 400 degrees F. because, unlike sorbent treated with NH₄Br, high temperatures are not needed to ensure that ammonia (NH₃) is separated from bromine (Br₂) to react with sulfur dioxide in the flue gas stream and thereby form a sticky ammonium sulfate substance on the surface of the sorbent particles.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for removing mercury from flue gas, the method comprising:
applying a precursor of a sticky substance to surfaces of carbonaceous sorbent particles;
injecting the carbonaceous sorbent particles into contact with flue gas, wherein the carbonaceous sorbent particles adsorb mercury from the flue gas and at least one of a temperature of the flue gas and a component of the flue gas changes the precursor into the sticky substance that increases the stickiness of the carbonaceous sorbent particles; and
removing the carbonaceous sorbent particles having mercury adsorbed thereon from the flue gas.

2. The method of claim 1, wherein the precursor of the sticky substance is ammonia or an ammonia compound and the sticky substance is ammonium sulfate.

3. The method of claim 2, further comprising:
applying bromine or a bromine compound to the carbonaceous sorbent particles.

4. The method of claim 3, wherein the precursor of the sticky substance is NH₄Br, and wherein the injecting step includes injecting the carbonaceous sorbent particles into contact with flue gas having a temperature at an initial point of contact with the carbonaceous sorbent of at least 400 degrees F. to decompose ammonia and at least one of bromine and a bromine compound from the NH₄Br.

5. The method of claim 3 wherein the temperature at the initial point of contact with the carbonaceous sorbent particles is between about 400 to about 1,100 degrees F.

6. The method of claim 4, wherein the NH₄Br is applied to the carbonaceous sorbent particles in liquid form.

7. The method of claim 6, wherein the amount of NH₄Br applied to the carbonaceous sorbent particles is about 1 to about 25 weight percent of the carbonaceous sorbent particles.

8. The method of claim 4, further comprising:
after applying the NH₄Br to the carbonaceous sorbent particles, heat treating the carbonaceous sorbent particles at a temperature between about 400 to about 1,100 degrees F.

9. The method of claim 8, wherein the heat treating is performed for up to about 3 hours.

10. The method of claim 8, wherein the heat treating is performed in a kiln.

11. The method of claim 8, further comprising:
milling the carbonaceous sorbent particles after heat treating the carbonaceous sorbent particles.

12. The method of claim 11, wherein the milling is performed in at least one of:
a jet mill, a roller mill, an impact mill, and a ball mill.

13. The method of claim 11, further comprising:
milling the carbonaceous sorbent particles before the NH₄Br is applied to the carbonaceous sorbent particles.

14. The method of claim 1, further comprising:
after applying the precursor and before the injecting step, milling the carbonaceous sorbent particles to de-agglomerate the carbonaceous sorbent particles.

15. The method of claim 1, wherein the precursor is applied on-site at the plant where the carbonaceous sorbent particles are to be used for mercury removal.

16. The method of claim 15, wherein the carbonaceous sorbent particles have been treated with bromine or a bromine compound before applying the precursor.

17. The method of claim 15, further comprising:
milling the carbonaceous sorbent particles to de-agglomerate the carbonaceous sorbent particles, wherein the milling step is performed after the applying step and wherein there is no intermediate storage of the carbonaceous sorbent particles between the milling step and the injection step.

18. The method of claim 1, wherein the carbonaceous sorbent is activated carbon.
